(19) United States
(12) Patent Application Publication
(10) Pub. No.: US 2012/0327954 A1
(43) Pub. Date: Dec. 27, 2012

(54) Packet Meta-Tagging Using Excess Payload

(75) Inventors: Andrei Iourtchenko, Woluwe-St.-Lambert (BE); Carlos M. Pignataro, Raleigh, NC (US); Daniel G. Wing, San Jose, CA (US)

(73) Assignee: CISCO TECHNOLOGY, INC., San Jose, CA (US)

(21) Appl. No.: 13/168,322

(22) Filed: Jun. 24, 2011

(51) Int. Cl. H04J 3/24

(52) U.S. Cl. 370/474

(57) ABSTRACT

Packet meta-tagging using excess payload is described. In an implementation, a total packet length value specified in packet received at a network element is adjusted while preserving a data length value associated with a data portion of the packet to generate additional space in the packet to accommodate packet transmission meta-data. Packet-transmission meta-data can be inserted into the additional space created in the packet by the network element. In some implementations, the meta-data describes packet transmission characteristics of the packet. For example, the meta-data can be a timestamp corresponding to the time at which the packet was received by the network element. The meta-data can be an identifier corresponding to the network element that received the packet.

### TECHNICAL FIELD

The present disclosure generally relates to network management.

### BACKGROUND

Networks are used for transmitting voice and video packets. Internet telephone services transmit voice packets to provide internet protocol (IP) telephone services to users. Internet video services transmit video packets to provide television shows, movies and homemade videos for users to watch. Video chat and video conferencing transmit both video and voice data packets. To ensure a positive user experience, service providers must ensure a certain quality of service for video and voice data delivery. For example, a movie that is streamed over the internet will not be enjoyable to watch if the movie is not streamed smoothly to a user's display. An internet protocol telephone call that exhibits intermittent loss of service or jitter (i.e., transmission delay variance) in transmitting the callers' voices will be irritating or disruptive to the participants in the telephone or video call. A method for monitoring and troubleshooting the transmission of voice and video data packets through the network may be useful in identifying and resolving packet transmission problems.

### BRIEF DESCRIPTION OF THE DRAWINGS

In the drawings:

FIG. 1 illustrates an example of a system that implements packet meta-tagging using excess payload;

FIGS. 2A and 2B illustrate example packets that can be meta-tagged using excess packet payload;

FIG. 3 illustrates an example of a method for packet meta-tagging using excess packet payload for reading meta-tags from excess packet payload;

FIG. 4 illustrates an example of a method for processing packets having excess packet payload; and

FIG. 5 illustrates an example of a computer system upon which an implementation can be realized.

### DETAILED DESCRIPTION

Packet meta-tagging using excess payload is described. In the following description, for the purposes of explanation, numerous specific details are set forth in order to provide a thorough understanding of aspects of packet meta-tagging using excess payload.

Implementations are described herein according to the following outline:
1.0 General Overview
2.0 Description of Particular Implementations
3.0 Packet Meta-tagging Using Excess Payload
   3.1 Packet Meta-tagging
   3.2 Processing Packets Having Excess Payload
4.0 Implementation Mechanisms—Hardware Examples
5.0 Extensions and Alternatives

### 1.0 GENERAL OVERVIEW

Packet meta-tagging using excess payload is described. In an implementation, a total packet length value specified in packet received at a network element is adjusted while preserving a data length value associated with a data portion of the packet to generate additional space in the packet to accommodate packet transmission meta-data. Packet-transmission meta-data can be inserted into the additional space created in the packet by the network element. In some implementations, the meta-data describes packet transmission characteristics of the packet. For example, the meta-data can be a timestamp corresponding to the time at which the packet was received by the network element. The meta-data can be an identifier corresponding to the network element that received the packet. The meta-data can include traceroute information (e.g., traceroute extension information), authentication information, packet sequencing information and/or checksum data, for example.

In some implementations, a packet containing a header portion, a data portion and an additional parts portion is received at a network element. The network element can determine that the packet includes the additional parts portion and read packet transmission meta-data from the additional parts portion. In some implementations, the meta-data is a timestamp inserted into the packet by another network element. In some implementations, determining that the packet includes the additional parts portion can be performed by comparing the total length of the packet to a summation of a length of the header portion and a length of the data portion. In some implementations, the receiving network element can replace the data in the additional parts portion with new packet transmission meta-data. In some implementations, the receiving network element can transmit the meta-data read from the additional parts portion to a network management device for processing.

Other implementations encompass a computer apparatus and a computer-readable medium configured to carry out the foregoing steps.

Particular implementations provide one or more of the following advantages: packet transmission data can be collected at and/or for each network element; packet transmission data can be collected without having to transmit the data back to the source of the packet transmission; and collected packet transmission data can be transmitted without having to generate additional or separate packets to transmit the collected data.

### 2.0 DESCRIPTION OF PARTICULAR IMPLEMENTATIONS

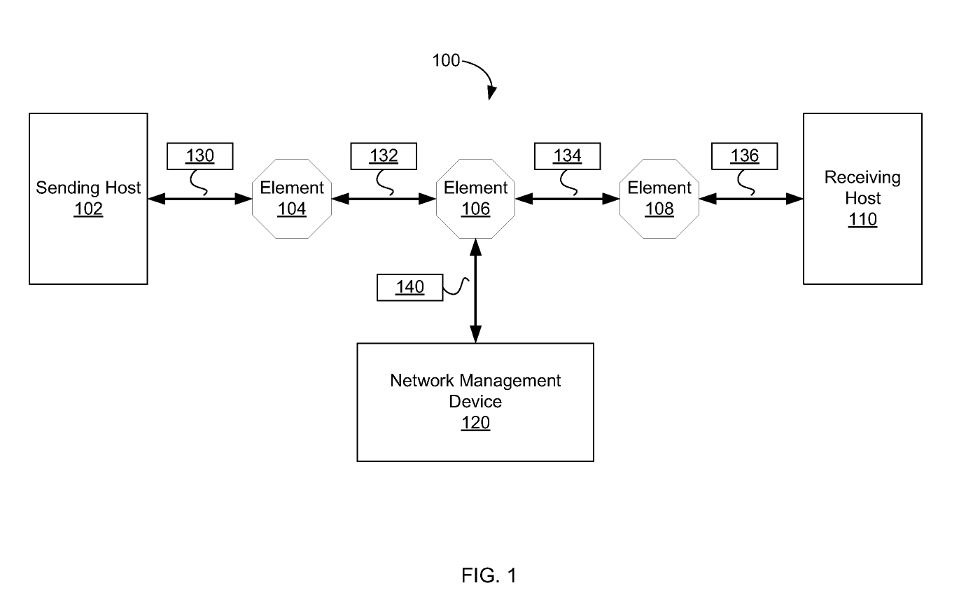

FIG. 1 illustrates an example of a system 100 that implements packet meta-tagging using excess packet payload. In some implementations, packets traveling through a network can be tagged with additional data (e.g., packet transmission meta-data) by network elements along the network path through which the packet travels. For example, sending host 102 can transmit a packet 130 to receiving host 110. Sending host 102 can be, for example, a video and/or voice service provider (e.g., an IP phone service, an internet video content delivery service, etc.). Receiving host 110 can be, for example, an end user device (e.g., terminal computing device) that is capable of processing and/or presenting the video and/or voice packet data. For example, receiving host 110 can be a computing device (e.g., a laptop computer, desktop computer, tablet computer, smartphone, etc.). Sending host 102 can transmit packet 130 to receiving host 110 along a network path that includes intermediate network elements 104-108. For example, intermediate network elements 104, 106 and 108 can be routers, switches, hubs and/or any other computing device attached to the network that participates in transmitting packets from one device to another.

In some implementations, intermediate network elements 104, 106 and/or 108 can meta-tag packets that are received by the network elements to add packet transmission meta-data to the packets. For example, intermediate network element 104 can receive packet 130 and meta-tag the packet (e.g., add data to the packet) to generate packet 132. Packet 132 can contain the contents of packet 130 plus packet transmission meta-data added to packet 130 by intermediate network element 104. For example, the packet transmission meta-data added to packet 130 can be timestamp information, network element identification information, routing information or any other information that can describe the transmission characteristics of the packet. Intermediate network element 104 can transmit meta-tagged packet 132 to the receiving host through intermediate network elements 106 and 108.

In some implementations, sending host 102 can meta-tag packets prior to sending the packets to receiving host 110 through intermediate network element 104. For example, sending host 102 can generate a packet (e.g., packet 130) that includes an additional parts section that includes packet transmission meta-data. The packet transmission meta-data can be timestamp information, network element identification information, routing information or any other information that can describe the transmission characteristics of the packet, for example. Thus, when intermediate node 104 receives packet 130, intermediate node 104 may receive a packet that has been meta-tagged with packet transmission characteristic information. In some implementations, receiving host 110 can be configured to process meta-tagged packets. For example, like intermediate network elements 104-108, receiving host 110 can process meta-tagged packets. Receiving host 110 can, for example, meta-tag a packet before sending the packet to intermediate network element 108.

In some implementations, network elements that receive meta-tagged packets can add their own meta-tags (e.g., packet transmission meta-data) to meta-tagged packets. For example, when intermediate network element 106 receives meta-tagged packet 132, intermediate network element 106 can tag (e.g., add meta-data) packet 132 with timestamp information indicating a time at which packet 132 was received by intermediate network element 106. The timestamp information added by intermediate network element 106 can be added to the timestamp information added by intermediate network element 104, for example, to generate packet 134. Similarly, when intermediate network element 108 receives meta-tagged packet 134, intermediate network element 108 can tag the packet to add its own meta-data (e.g., timestamp, network element identifier, etc.) to generate meta-tagged packet 136. Thus, packet 136 generated by intermediate network element 108 can include the packet transmission meta-data added by intermediate network elements 104-108 (e.g., timestamps, device identifiers, etc. added by each network element).

In some implementations, meta-data added to meta-tagged packets by intermediate network elements can replace the meta-data that was added by other intermediate network elements and that is already stored in the packet. For example, instead of just adding packet transmission meta-data (e.g., timestamps, device identifiers, etc.) to existing meta-data in the packet, intermediate network element 106 can replace the meta-data (e.g., timestamp) added to packet 132 by intermediate network element 104 with meta-data generated by intermediate network element 106. Thus, packet 134 generated by intermediate network element 106 will include only the packet transmission meta-data added by intermediate network element 106.

In some implementations, network elements and/or computing devices that receive and/or transmit meta-tagged packets can process the meta-tagged packets and/or the packet transmission meta-data. In some implementations, network elements and/or a receiving host can process the meta-tagged packets to read or extract the meta-data from the meta-tagged packet. For example, intermediate network elements 104-108 and/or receiving host 110 can receive and process the meta-tagged packets to extract timestamps, device identifiers or other packet transmission meta-data.

In some implementations, the packet transmission meta-data can be processed to determine various network characteristics to aid in network monitoring and troubleshooting. For example, packets that have been meta-tagged with meta-data that includes timestamps can be processed to extract the timestamp information. The timestamp information can be processed to determine packet transmission characteristics, such as transmission delay and/or transmission delay variances (i.e., “jitter”). For example, the packet transmission meta-data (e.g., timestamp information) can be processed at one of the intermediate network elements 104-108, the receiving host 110 or network management device 120. Intermediate network elements 104-108 can extract the meta-data and transmit the meta-data to network management device 120 for processing (e.g., using packet 140). Intermediate network elements 104-108, receiving host 110 and/or network management device 120 can analyze the meta-data (e.g., timestamp information, device identifier information, etc.) to determine which segments of the network might be the source of variation in packet transmission delay, where the packet entered the network and/or what path the packet took through the network, for example. The analysis can be performed to assist in network troubleshooting activities.

### 3.0 PACKET META-TAGGING USING EXCESS PAYLOAD

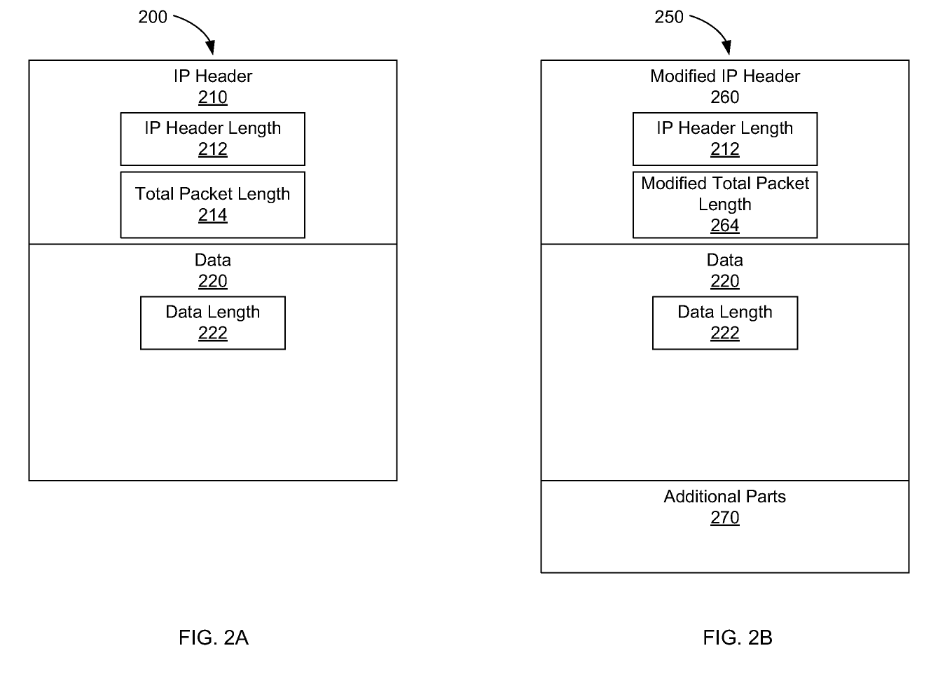

FIGS. 2A and 2B illustrate example packets 200 and 250 that can be meta-tagged using excess packet payload. The structure of internet protocol (IP) packets are well known, thus only the portions of the packet relevant to this disclosure will be described. Packet 200 includes an internet protocol (IP) header section 210 and a data section 220. IP header section includes, among other things, an IP header length field 211 and a total packet length field 214. The IP header length field 211 contains an IP header length value that specifies the length of the IP header. The total packet length field 214 contains a total packet length value that specifies the length of the entire packet, including data section 220. Data section 220 includes a data length field 222 that contains a data length value that specifies the length of data section 220. For example, the total packet length (tpl) value can be calculated by adding the data length (dl) value from data length field 222 to the IP header length (iphl) value multiplied by four (the IP header length value must be converted from words to bytes; 1 word=4 bytes). Thus, tpl=dl+(iphl*4).

In some implementations, packet 200 can be processed by a network element to generate a packet 250 that includes an additional parts section 270. For example, the additional parts section 270 can be used to store the packet transmission meta-data described above with reference to FIG. 1. In some implementations, packet 200 can be received by an intermediate network element as packet 200 is transmitted through a network. The intermediate network element can modify the total packet length value stored in total packet length field 214 to generate a modified total packet length value 264. In some implementations, the total packet length value in total packet length field 214 can be increased according to the length of meta-data to be added to additional parts section 270. For example, if a timestamp is one (1) byte in length, then the total packet length value can be increased by one byte to generate an additional parts section 270 of one byte in length to accommodate the one byte timestamp.

In some implementations, the data length value in data length field 222 is not changed when the total packet length value is changed. For example, changing the total packet length value while preserving the data length value can generate the additional parts section 270 into which packet transmission meta-data is inserted. Moreover, by preserving the length of data section 220, devices or network elements that are configured to read data section 220 but that are not configured to read additional parts section 270 will ignore the data in additional parts section 270 when reading data from data section 220. For example, devices that are configured to read data section 220 but not configured to read additional parts section 270 will stop reading data section 220 once the devices have read an amount of data corresponding to the data length value specified in data length field 222.

Similarly, packet 250 can be processed by intermediate network elements to modify the length of additional parts section 270 and add meta-data to meta-data already in additional parts section 270. For example, the length of additional parts section 270 can be increased by increasing the value stored in total packet length field 264 according to a length of meta-tag information to be added to packet 250 while preserving the value stored in data length field 222. Thus, additional parts section 270 can be enlarged to accommodate additional packet transmission meta-data.

### 3.1 PACKET META-TAGGING

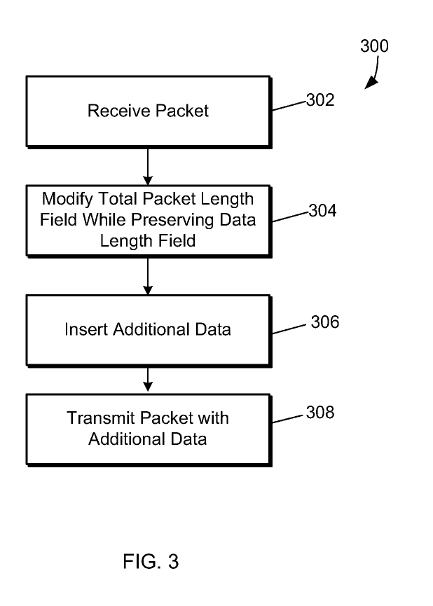

FIG. 3 illustrates an example of a process 300 for packet meta-tagging using excess packet payload for reading meta-tags from excess packet payload. At step 302, a packet is received. For example, a packet (e.g., a user datagram protocol (UDP) packet) can be received at an intermediate network element. The packet can be configured to transport voice and/or video data to a receiving device capable of presenting the voice and/or video data to a user of the receiving device.

At step 304, the total packet length field of the received packet can be modified while preserving the data length field of a data section of the packet. For example, the intermediate network element that receives the packet can be configured to tag the packet with packet transmission meta-data (e.g., timestamp information, network element identification information, etc.). To generate an additional parts section for the meta-data, the intermediate network element can increase the size of the packet to accommodate the meta-data. The additional parts section can be created in the packet by increasing the size of the packet without increasing the size of the data section of the packet. This can be done by increasing the total packet length field value without changing the data length field value of the packet. For example, the total packet length field value can be increased according to the length of the meta-data to be inserted into the packet while preserving the value stored in the data length field. Modifying the total packet length without modifying the data length can generate space at the end of the packet (e.g., after the data section) into which the intermediate network element can insert the meta-data, thereby, allowing the intermediate network element to meta-tag the packet with network element and/or packet transmission information.

At step 306, additional data can be inserted into the modified packet. For example, meta-data (e.g., timestamp information and/or network element identification information) can be inserted into the additional parts section of the packet generated at step 304. In some implementations, the meta-data can be added to meta-data already in the packet. For example, the received packet can already be meta-tagged and have an additional parts section that includes packet transmission meta-data. The additional parts section can be expanded at step 304 and additional meta-data can be added to the meta-data already in the additional parts section at step 306.

At step 308, the meta-tagged packet having the added meta-data can be transmitted to a device on the network. For example, the intermediate network element that meta-tagged the packet can transmit the packet along a network path to a destination device. While the meta-tagged packet is transmitted along the network path, the meta-tagged packet can be processed and meta-tagged by other intermediate network elements along the network path. Thus, the destination device can receive a meta-tagged packet with meta-data inserted by one or more intermediate network elements that were on the network path through which the packet was transmitted.

In some implementations, the meta-data can be used to monitor and troubleshoot network packet flows. For example, packets can be meta-tagged with timestamp information from each intermediate network element on a network path along which the packets was transmitted. Transmission delays can be calculated based on the timestamp information. For example, a transmission delay can be calculated for segments of the network path between two intermediate network elements and/or devices based on packet transmission meta-data read from a meta-tagged packet. Transmission delay variances (i.e., jitter) can be calculated by comparing the transmission delays calculated for each packet to transmission delays calculated for other packets. If the transmission delay for the packets varies too much, the source of the transmission delay variance can be determined by analyzing the packet transmission delay data to identify which network segments are contributing to the increased transmission delay variances. Moreover, network element identifiers read from meta-tagged packets can be used to determine entry and exit points on the network or to determine the network path along which a packet has traveled. Thus, meta-tagged packets can be used to monitor and troubleshoot packet transmission through a network. These network monitoring and troubleshooting calculations can be performed by a network management device attached to the network or by the receiving host (e.g., terminal) device.

### 3.2 PROCESSING PACKETS HAVING EXCESS PAYLOAD

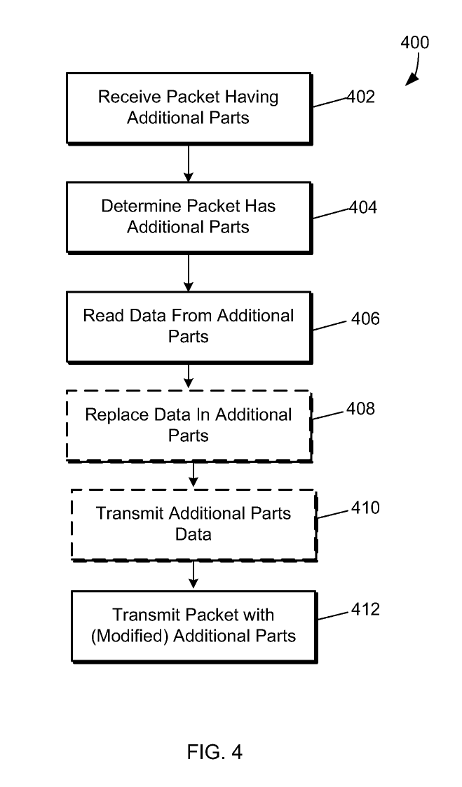

FIG. 4 illustrates an example of a process 400 for processing packets having excess packet payload. At step 402, a packet having an additional parts section is received by a network element or destination (e.g., terminal) device. For example, an intermediate network element can receive a packet having an additional parts section, as described above. If the intermediate network element is not configured to process the additional parts section, the network element can ignore the additional parts section and process the packet in a usual manner.

At step 404, the network element or destination device can determine that the packet has additional parts. For example, the intermediate network element can analyze the total packet length (214 or 264, FIG. 2), the packet header length (212, FIG. 2) and the data length (222, FIG. 2) fields of the packet (200 or 250, FIG. 2) to determine whether the packet has an additional parts section. For example, for a packet without an additional parts section, the total packet length (tpl) value can be calculated by adding the data length (dl) value from data length field 222 to the IP header length (iphl) value multiplied by four (the IP header length value must be converted from words to bytes; 1 word=4 bytes). Thus, tpl=dl+(iphl*4). To determine whether a packet includes an additional parts section, the summation of the data length and the IP header length can be subtracted from the total packet length (e.g., tpl−(dl+(iphl*4))). If the difference is zero (e.g., tpl−(dl+(iphl*4))=0), then the packet has no additional parts section. If the difference is greater than zero (e.g., tpl−(dl+(iphl*4))>0), then the packet has an additional parts section. If the difference is less than zero (e.g., tpl−(dl+(iphl*4))<0), then the packet is malformed or there is an error in one of the length fields (e.g., IP header length, total packet length, data length) of the packet.

At step 406, meta-data can be read from the additional parts section of the packet. For example, if the intermediate network element or destination device has determined that the packet has an additional parts section (e.g., if tpl−(dl+(iphl*4))>0), then the network element or device can read the meta-data from the additional parts section. The network element or device can read meta-data (e.g., timestamp information, device identification information) inserted into the additional parts section by other network elements or devices that have previously processed the packet. In some implementations, the network element or device can extract or remove the meta-data from the packet once it is read. For example, the network element reading the meta-data from the packet can remove the meta-data and adjust the total packet length value to remove the additional parts section from the packet. In some implementations, the network element or device can leave the meta-data in the packet once the meta-data is read. After reading the meta-data from the additional parts section, the intermediate network element or device can process the meta-data locally (e.g., on the network element). In some implementations, the network element or destination device can transmit the meta-data read from the additional parts section of the packet to another device (e.g., a network management device) for processing. For example, the meta-data can be processed as part of network monitoring and troubleshooting activities, as described above.

Optionally, at step 408, the network element can replace the meta-data in the additional parts section of the packet with other meta-data. For example, the intermediate network element can replace a timestamp stored in the additional parts section of the packet with a new timestamp. The new timestamp can represent a time at which the packet was received at the intermediate network element, for example. The intermediate network element can replace a network element identifier associated with a previous network element with a network identifier for the intermediate network element. In some implementations, meta-data stored in the additional parts section of a packet is not replaced with new meta-data. Instead, the additional parts section of the packet can be expanded to accommodate the new meta-data and the new meta-data is added to the additional parts section without replacing meta-data that is already stored in the additional parts section.

Optionally, at step 410, the meta-data read from the additional parts section at step 406 can be transmitted to another device. For example, the intermediate network element or destination device that read the meta-data from the additional parts section at step 406 can be configured to transmit the meta-data to another device on the network. The other device can be a device that is configured to perform network management activities (e.g., monitoring and troubleshooting activities). The network management device can collect meta-data (e.g., timestamp, network element identification information) from network elements and process the meta-data to identify and troubleshoot problems with the network and network packet flows, as described above.

At step 412, the packet having additional parts can be transmitted from the network element currently processing the packet to the next network element and/or the destination device. For example, the intermediate network element can transmit the packet having a modified (e.g., replaced, expanded, added) additional parts section to another network element or to the destination device to which the packet is addressed. In some implementations, if the network element has removed the meta-data and the additional parts section from the packet, the packet can be transmitted without an additional parts section.

In some implementations, a terminal device (e.g., receiving host 110) can receive meta-tagged packets and process the packets to extract meta-data. When the terminal device is processing meta-tagged packets, the terminal device may not retransmit the received meta-tagged packet.

### 4.0 IMPLEMENTATION MECHANISMS—HARDWARE EXAMPLES

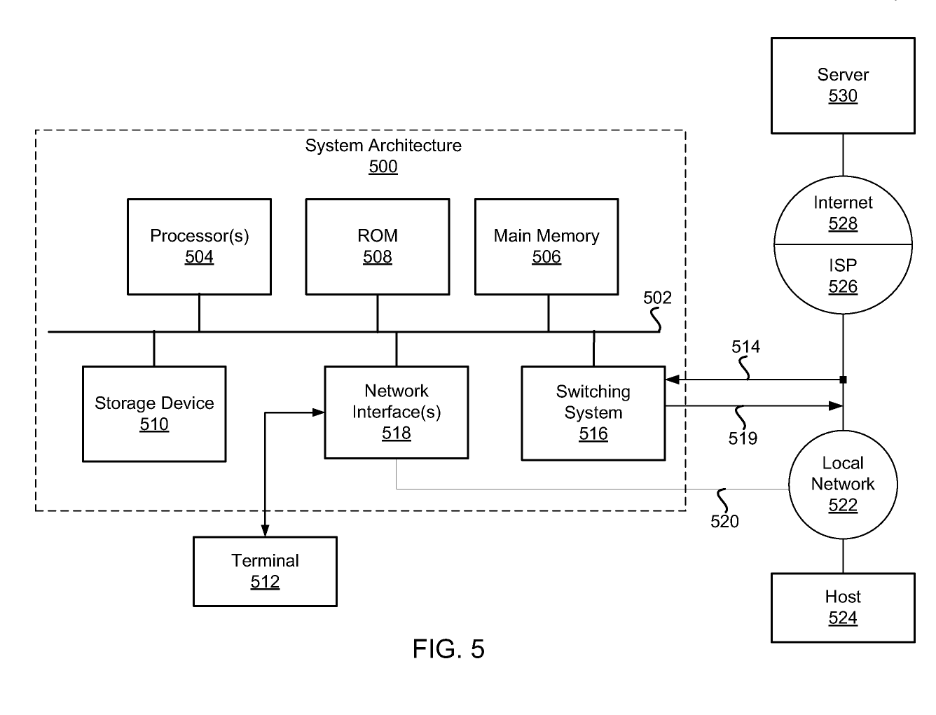

FIG. 5 is a block diagram that illustrates a computer system 500 upon which an implementation can be realized. Some implementations can be realized using one or more computer programs running on a network element (e.g., a router device, switch, etc.). Thus, in this implementation, the computer system 500 is a router.

Computer system 500 includes a bus 502 or other communication mechanism for communicating information, and a processor 504 coupled with bus 502 for processing information. Computer system 500 also includes a main memory 506 (e.g., a random access memory (RAM), flash memory, or other dynamic storage device) coupled to bus 502 for storing information and instructions to be executed by processor 504. Main memory 506 also can be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510 (e.g., a magnetic disk, flash memory or optical disk) is provided and coupled to bus 502 for storing information and instructions.

A network interface 518 can be coupled to bus 502 for communicating information and command selections to processor 504. Interface 518 can be a serial interface (e.g., an RS-232 or RS-422 interface). An external terminal 512 or other computer system connects to the computer system 500 and provides commands to it using the interface 518. Firmware or software running in the computer system 500 provides a terminal interface or character-based command interface so that external commands can be given to the computer system.

A switching system 516 is coupled to bus 502 and has an input interface 514 and an output interface 519 to one or more external network elements. The external network elements can include a local network 522 coupled to one or more hosts 524, or a global network (e.g., Internet 528) having one or more servers 530. The switching system 516 switches information traffic arriving on input interface 514 to output interface 519 according to pre-determined protocols and conventions. For example, switching system 516, in cooperation with processor 504, can determine a destination of a packet of data arriving on input interface 514 and send it to the correct destination using output interface 519. The destinations can include host 524, server 530, other end stations, or other routing and switching devices in local network 522 or Internet 528.

The described techniques related to the use of computer system 500 for packet meta-tagging using excess payload. According to one implementation, packet meta-tagging using excess payload is performed by computer system 500 in response to processor 504 executing one or more sequences of one or more instructions contained in main memory 506. Such instructions can be read into main memory 506 from another computer-readable medium (e.g., storage device 510). Execution of the sequences of instructions contained in main memory 506 causes processor 504 to perform the process steps described herein. One or more processors in a multi-processing arrangement can also be employed to execute the sequences of instructions contained in main memory 506. In alternative implementations, hard-wired circuitry can be used in place of or in combination with software instructions. Thus, implementations are not limited to any specific combination of hardware circuitry and software.

The term “computer-readable medium” as used herein refers to any medium that participates in providing instructions to processor 504 for execution. Such a medium can take many forms, including but not limited to, non-volatile storage media, volatile storage media, and transmission media. Non-volatile storage media includes, for example, optical or magnetic disks (e.g., storage device 510). Volatile storage media includes dynamic memory (e.g., main memory 506). Transmission media includes coaxial cables, copper wire and fiber optics, including the wires that comprise bus 502. Transmission media can also take the form of acoustic or light waves (e.g., those generated during radio wave and infrared data communications).

Common forms of computer-readable storage media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, or any other tangible storage medium from which a computer can read.

Various forms of computer readable storage media can be involved in carrying one or more sequences of one or more instructions to processor 504 for execution. For example, the instructions can initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 can optionally be stored on storage device 510 either before or after execution by processor 504.

Network interface 518 also provides a two-way data communication coupling to a network link 520 that is connected to a local network 522. For example, network interface 518 can be an integrated services digital network (ISDN) card or a modem to provide a data communication connection to a corresponding type of telephone line. As another example, network interface 518 can be a local area network (LAN) card to provide a data communication connection to a compatible LAN. Wireless links can also be implemented. In any such implementation, network interface 518 sends and receives electrical, electromagnetic or optical signals that carry digital data streams representing various types of information.

Network link 520 typically provides data communication through one or more networks to other data devices. For example, network link 520 can provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through network interface 518, which carry the digital data to and from computer system 500, are exemplary forms of carrier waves transporting the information.

Computer system 500 can send messages and receive data, including program code, through the network(s), network link 520 and network interface 518. In the Internet example, a server 530 might transmit a requested code for an application program through Internet 528, ISP 526, local network 522 and network interface 518. For example, one such downloaded application provides for packet meta-tagging using excess payload as described herein. The received code can be executed by processor 504 as it is received, and/or stored in storage device 510, or other non-volatile storage for later execution.

### 5.0 EXTENSIONS AND ALTERNATIVES

In the foregoing specification, implementations have been described with reference to numerous specific details that can vary from implementation to implementation. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
obtaining, at a computing device, a packet having a header portion and a data portion, the header portion including a total length field that specifies a total packet length value corresponding to the total length of the packet, the data portion including a data length field that specifies a data length value corresponding to the length of the data portion;
increasing, at the computing device, the total packet length value according to a length of additional data to be added to the packet while preserving the data length value;
inserting, at the computing device, the additional data into a new portion of the packet generated by increasing the total packet length value; and
transmitting the packet to a network device.

2. The method of claim 1, wherein inserting the additional data into the new portion of the packet comprises inserting a timestamp into the new portion of the packet.

3. The method of claim 2, further comprising:
determining a time at which the packet was obtained by the computing device; and
generating the timestamp based on the determined time.

4. The method of claim 1, wherein inserting the additional data into the new portion of the packet comprises inserting an identifier for the computing device into the new portion of the packet.

5. A method comprising:
receiving, at a computing device, a packet including a header portion, a data portion, and an additional parts portion;
determining that the packet includes the additional parts portion, where the additional parts portion is separate from the data portion; and
reading data from the additional parts portion.

6. The method of claim 5, wherein determining that the packet includes the additional parts portion comprises:
comparing a total length of the packet to a summation of a length of the header portion and a length of the data portion.

7. The method of claim 5, wherein the data is a timestamp inserted into the packet by another network element.

8. The method of claim 5, further comprising:
replacing the data in the additional parts portion with new data at the network element.

9. The method of claim 5, wherein the header portion includes a total length field that specifies a packet length value corresponding to the total length of the packet, wherein the data portion includes a data length field that specifies a data length value corresponding to the length of the data portion, and further comprising:
increasing the packet length value according to a length of additional data to be added to the packet while preserving the data length value;
inserting the additional data into space created in the additional parts portion of the packet by increasing the packet length value; and
transmitting the packet to a network device.

10. The method of claim 5, further comprising:
transmitting the data read from the additional parts portion to a network management device for processing.

11. A non-transitory computer-readable medium including one or more sequences of instructions which, when executed by one or more processors, causes:
obtaining, at a computing device, a packet having a header portion and a data portion, the header portion including a total length field that specifies a total packet length value corresponding to the total length of the packet, the data portion including a data length field that specifies a data length value corresponding to the length of the data portion;
increasing, at the computing device, the total packet length value according to a length of additional data to be added to the packet while preserving the data length value;
inserting, at the computing device, the additional data into a new portion of the packet generated by increasing the packet length value; and
transmitting the packet to a network device.

12. The non-transitory computer-readable medium of claim 11, wherein inserting the additional data into the new portion of the packet comprises inserting a timestamp into the new portion of the packet.

13. The non-transitory computer-readable medium of claim 12, further comprising:
determining a time at which the packet was obtained by the computing device; and
generating the timestamp based on the determined time.

14. The non-transitory computer-readable medium of claim 11, wherein inserting the additional data into the new portion of the packet comprises inserting an identifier for the computing device into the new portion of the packet.

15. A non-transitory computer-readable medium including one or more sequences of instruction which, when executed by one or more processors, causes:
receiving, at a computing device, a packet including a header portion, a data portion, and an additional parts portion;
determining that the packet includes the additional parts portion, where the additional parts portion is separate from the data portion; and
reading data from the additional parts portion.

16. The non-transitory computer-readable medium of claim 15, wherein the instructions that cause determining that the packet includes the additional parts portion comprise instructions that cause:
comparing a total length of the packet to a summation of a length of the header portion and a length of the data portion.

17. The non-transitory computer-readable medium of claim 15, wherein the data is a timestamp inserted into the packet by another network element.

18. The non-transitory computer-readable medium of claim 15, wherein the instructions cause:
replacing the data in the additional parts portion with new data at the network element.

19. The non-transitory computer-readable medium of claim 15, wherein the header portion includes a total length field that specifies a packet length value corresponding to the total length of the packet, wherein the data portion includes a data length field that specifies a data length value corresponding to the length of the data portion, and wherein the instructions cause:
increasing the packet length value according to a length of additional data to be added to the packet while preserving the data length value;
inserting the additional data into space created in the additional parts portion of the packet by increasing the packet length value; and
transmitting the packet to a network device.

20. The non-transitory computer-readable medium of claim 15, wherein the instructions cause:
transmitting the data read from the additional parts portion to a network management device for processing.

21. The method of claim 1, wherein the new data includes traceroute information.

22. The method of claim 1, wherein the new data includes authentication information.

23. The method of claim 1, wherein the new data includes packet sequencing information.

24. The method of claim 1, wherein the new data includes checksum information.

25. The method of claim 5, further comprising:
removing the additional parts portion, including the data from the additional parts portion, from the packet by adjusting a total packet length value of the packet to equal a sum of a length of the header portion and a length of the data portion; and
transmitting the packet to a network device.

26. A method comprising:
generating, at a computing device, a packet having a header portion, a data portion and an additional parts portion, the header portion including a total length field that specifies a total packet length value corresponding to the total length of the packet, the data portion including a data length field that specifies a data length value corresponding to the length of the data portion;
generating the additional parts portion by setting the total packet length value to a value determined based on a length of the header portion, a length of the data portion and a length of additional data to be inserted into the additional parts portion;
inserting, at the computing device, the additional data into the additional parts portion of the packet; and
transmitting the packet to a network device.

27. A system comprising:
at least one processor; and
a computer-readable medium including one or more sequences of instructions which, when executed by the at least one processor, causes:
receiving a packet having a header portion, a data portion and an additional parts portion, the header portion comprising a total packet length value and a packet header length value, the data portion comprising a data length value;
calculating a difference between the total packet length and a sum of the packet header length and the data length based on the total packet length value, the packet header length value and the data length value; and
determining that the packet includes the additional parts portion based on the calculation.

28. The system of claim 27, wherein the instructions that cause determining that the packet includes the additional parts portion comprise instructions that cause determining that the difference is greater than zero.

29. The system of claim 27, further comprising instructions that cause:
reading an amount of data substantially equal to the calculated difference from the additional parts portion of the packet.
